(19) United States
(12) Patent Application Publication
(10) Pub. No.: US 2024/0390753 A1
(43) Pub. Date: Nov. 28, 2024

(54) NOISE CONTROLLED PADDLE

(71) Applicant: HUMMINGBIRD SPORT LIMITED PARTNERSHIP, Vancouver (CA)

(72) Inventors: Howard HAUGOM, Victoria (CA); Fang XIE, Vancouver (CA); Jordan Willem MIKKERS, Victoria (CA)

(21) Appl. No.: 18/674,091

(22) Filed: May 24, 2024

Related U.S. Application Data
(60) Provisional application No. 63/602,523, filed on Nov. 24, 2023.
(60) Provisional application No. 63/590,152, filed on Oct. 13, 2023.
(60) Provisional application No. 63/504,076, filed on May 24, 2023.

(51) Int. Cl. A63B 60/54; A63B 59/42; A63B 102/08; B32B 3/04; B32B 5/02; B32B 5/26

(52) U.S. Cl. CPC A63B 60/54; A63B 59/42; B32B 3/04; B32B 5/02; B32B 5/26; A63B 2102/08; A63B 2209/02; B32B 2260/023; B32B 2260/046; B32B 2262/0253; B32B 2262/0261; B32B 2262/106; B32B 2307/102; B32B 2307/7265

(57) ABSTRACT

A pickleball paddle is provided with improvements or modifications to control noise. Embodiments described relate to pickleball paddles for reducing the loudness and/or frequency of sound generated when a ball strikes the pickleball paddle. In some embodiments, the paddle comprises a surface comprising a graphene infused acoustic layer. In some embodiments, the graphene infused acoustic layer comprises between about 1% to 25% graphene. In some embodiments, the graphene infused acoustic layer comprises an effective amount of graphene to provide durability. The paddle can reduce frequency of sound generated to between 500 hz to 800 hz.

### CROSS-REFERENCE TO RELATED APPLICATIONS

The application claims the benefit of U.S. provisional application No. 63/504,076 filed on May 24, 2023, U.S. provisional application No. 63/590,152 filed on Oct. 13, 2023, and U.S. provisional application No. 63/602,523 filed on Nov. 24, 2023, all titled “Noise Controlled Paddle”, the entire contents of which are incorporated herein by reference.

### FIELD

The present disclosure generally relates to the field of sport equipment, and in particular, the present disclosure relates to paddles, such as pickleball paddles.

### BACKGROUND

Pickleball is an indoor or outdoor racket or paddle sport where two or four players hit a perforated hollow plastic ball over a net using solid-faced paddles. Pickleball has become one of the fastest-growing sports in North America and various national and international Pickleball organization and foundations have been established to organize and regulate the sport.

Amidst the growing popularity however, the sport has also attracted petitions and lawsuits due to noise complaints. The noise generated from impact between ball and paddle can be significantly louder than tennis or other racket sports. In addition, elbow pain has been a serious concern for pickle ball players. A large percentage of Pickleball players are often playing while wounded, wrapped up in braces or bands, or even dropping out of matches due to elbow pain. One theory regarding the elbow pain is that the vibrations involved in hitting a hard, plastic Pickleball with the paddle used in the game, are considerably more intense than the vibrations involved in hitting a tennis ball with a tennis racket.

As a result, there is a need for improved equipment that reduces noise and dampens vibration without compromising play.

### SUMMARY

In an aspect, there is provided a pickleball paddle for reducing the loudness and/or frequency of sound generated when a ball strikes the pickleball paddle, the paddle having a graphene infused acoustic layer applied on one or both sides of the paddle.

In an aspect, there is provided a pickleball paddle for reducing the loudness and/or frequency of sound generated when a ball strikes the pickleball paddle, wherein the paddle comprises a playing surface with an acoustic layer, wherein the acoustic layer comprises an acoustic fabric comprising woven or non-woven fabric and a durability enhancing agent.

In some embodiments, a durability enhancing agent is a carbon-based material.

In some embodiments, an acoustic layer comprises a graphene infused fabric.

In some embodiments, a graphene infused fabric contains about 1% to about 25% by weight of graphene, preferably 5% to 15% by weight of the graphene, and more preferably 7% to 12% by weight of the graphene.

In some embodiments, a graphene infused fabric comprises approximately 10% by weight of the graphene.

In some embodiments, a graphene infused fabric comprises the graphene and at least one polymer.

In some embodiments, a graphene infused fabric comprises polymer fibers.

In some embodiments, polymer fibers comprise nylon and/or polypropylene.

In some embodiments, polymer fibers comprise N66.

In some embodiments, a pickleball paddle comprises N66 infused with graphene powder.

In some embodiments, a graphene infused fabric comprises graphene, N66 and polypropylene, wherein the graphene infused fabric comprises: between 5% to 15% graphene, between 40% to 60% N66, and between 30% to 40% polypropylene.

In some embodiments, a graphene infused fabric further comprises a waterproofing additive.

In some embodiments, an acoustic layer is applied on a surface layer of the paddle.

In some embodiments, a playing surface is covered with the acoustic fabric.

In some embodiments, an acoustic layer is applied on both opposing surface layers of the paddle.

In some embodiments, a pickleball paddle further comprises an acoustic fabric edge.

In some embodiments, an acoustic layer comprises a shell encasing the pickleball paddle.

In some embodiments, a pickleball paddle further comprises an internal graphene infused acoustic layer, wherein the internal graphene infused acoustic layer is sandwiched between two core layers.

In some embodiments, a pickleball paddle comprises a layer of carbon fiber applied to the outside of the surface of the paddle.

In some embodiments, a pickleball paddle comprises one or more layers of carbon fiber board.

In some embodiments, a layer of carbon fiber is applied as a composite comprised of the acoustic layer applied over a carbon fiber layer.

In an aspect, there is provided a pickleball paddle for reducing the loudness and/or frequency of sound generated when a ball strikes the pickleball paddle, wherein the paddle comprises a surface, the surface comprising an acoustic layer, wherein the acoustic layer comprises graphene and at least one fabric, wherein the acoustic layer reduces a frequency of sound generated to between 500 hz to 800 hz, wherein the acoustic layer comprises an effective amount of graphene to enhance durability of the surface.

In an aspect, there is provided a pickleball paddle for reducing the loudness and/or frequency of sound generated when a ball strikes the pickleball paddle, wherein the paddle comprises a surface, the surface comprising a fabric acoustic layer to reduce a frequency of sound generated to between 500 hz to 800 hz.

In an aspect, there is provided a pickleball paddle further comprising one or more modifications selected from: a subsurface layer between a core an outer layer of the paddle, to increase bounce and reduce the trampoline effect; a recessed insert in the core; and a non-uniform weight distribution.

In an aspect, there is provided a pickleball paddle further comprising a serrated or ridged edge.

In an aspect, there is provided a graphene infused fabric for a graphene infused acoustic layer of a paddle or racquet frame, the fabric comprising polymer fiber and between about 1% and about 25% by weight of graphene.

In an aspect, there is provided a pickleball paddle for reducing the loudness and/or frequency of sound generated when a ball strikes the pickleball paddle, wherein the paddle comprises a playing surface with an acoustic layer, wherein the acoustic layer comprises a graphene infused fabric.

In some embodiments, a pickleball paddle comprises a head and a handle, wherein the head comprises the playing surface.

In some embodiments, the head comprises a plurality of layers, the playing surface being an outer layer of the plurality of layers.

In some embodiments, the acoustic layer is the outer layer.

In some embodiments, the acoustic layer has a coating or cover or skin.

In some embodiments, the plurality of layers comprise a core.

In some embodiments, the core is sandwiched between the outer layers.

In some embodiments, the acoustic layer is a layer of the plurality of layers.

In some embodiments, the head has a width and a height, wherein the acoustic layer covers the entire width and height of the head.

In some embodiments, the playing surface comprises two sides or two faces.

In some embodiments, the acoustic layer covers the two sides or two faces.

In some embodiments, the acoustic layer is applied on a surface layer of the paddle.

In some embodiments, the playing surface has an outer face plate, wherein the acoustic layer is applied on the outer face plate.

In some embodiments, the playing surface is covered with the graphene infused fabric.

In some embodiments, a pickleball paddle further comprising an acoustic fabric edge.

In some embodiments, the acoustic fabric edge extends around the periphery of the head.

In some embodiments, the playing surface is a hitting surface.

In some embodiments, the acoustic layer provides an outer surface of the playing surface.

In some embodiments, the acoustic layer provides a sound reducing layer.

In some embodiments, the graphene infused fabric provides durability for the acoustic layer.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments of devices, apparatus, methods, and kits are described throughout reference to the drawings.

FIG. 1 shows a perspective view of a pickleball paddle having an acoustic surface.

FIG. 2 shows a pickleball paddle with an X-shaped insert. A) perspective view, B) top view, C) front view, D) cross-sectional plane view, and E) cross-sectional side view along line B-B.

FIG. 3 shows a pickleball paddle with an Y-shaped insert. A) perspective view, B) top view, C) front view, D) cross-sectional plane view, and E) cross-sectional side view along line B-B.

FIG. 4 shows a pickleball paddle with an A-shaped insert. A) perspective view, B) top view, C) front view, D) cross-sectional plane view, and E) cross-sectional side view along line B-B.

FIG. 5 shows a pickleball paddle with an 5-point shaped insert. A) perspective view, B) top view, C) front view, D) cross-sectional plane view, and E) cross-sectional side view along line B-B.

FIG. 6 shows a pickleball paddle with core exposed. A) perspective view, B) expanded view.

FIG. 7 shows a core layer of a pickleball paddle. The circles represent bores in the core layer.

FIG. 8 shows a core layer of a pickleball paddle, with X-shaped reinforcement.

FIG. 9 shows frequency analysis of modified pickleball paddles.

FIGS. 10A-10D show a pickleball paddle with an acoustic layer sandwiched between two honeycomb layers. A) perspective view, B) side view, C) exploded side view, and D) exploded perspective view.

FIG. 11 shows a pickleball paddle with ridges added to the outer profile of the paddle.

FIGS. 12A-12C show different views of a pickleball paddle, according to some embodiments.

FIG. 13 shows a pickleball paddle with an acoustic layer on the outside. A) perspective view, B) exploded side view, and C) exploded perspective view.

FIGS. 14A-14B show a pickleball paddle with an acoustic fabric shell. A) exploded perspective view, and B) perspective view.

FIGS. 15A-15C show a tool for manufacturing an acoustic fabric shell. A) metal heat sealing plate, B) assembled manufacturing tool and pickleball paddle, and C) exploded view of assembled manufacturing tool and pickleball paddle.

FIG. 16 shows Real Time Analyzer (RTA) audio spectrum output comparing Babalat Touch™ pickleball paddle (dark solid line) and a quiet pickleball paddle (dashed line) having graphene infused fabric according to the present description. X-axis represent sound frequency, Y-axis represents sound pressure level (SPL) in decibels.

FIGS. 17A-C show a pickleball paddle with an acoustic layer on the outside and a solid core. A) perspective view, B) exploded side view, C) exploded perspective view.

FIG. 18 shows an exploded perspective view of a pickleball paddle with sensors.

### DETAILED DESCRIPTION

Numerous details are set forth to provide an understanding of the examples described herein. The examples may be practiced without these details. The description is not to be considered as limited to the scope of the examples described herein.

Existing pickleball paddle construction uses a sandwich design, where a core material (e.g., honeycomb material) is sandwiched between two outer layers which serve as the playing surface. This sandwich design can give the paddle core strength. The surface layers can be made of wood, wood composite, graphite, carbon fiber, or fiberglass. The honeycomb core will generally be made of ½ inch or ⅜ inch aluminum, resin impregnated paper, or a polymer (such as plastic). Other core material, structure, or pattern may also be used. In one embodiment, the paddle is made from graphite.

Existing pickleball paddles may have a hard cover or surface, or are made of a graphite and resin composite material. Carbon fiber and graphite fiber composites as well as resin impregnated graphite, are materials often used in the manufacture of sport equipment where high strength and hardness are desired. However, when graphite or resin is used as a material for a paddle surface, it creates a hard surface that is the source of noise. Given the hardness, a graphite composite or resin-impregnated graphite has limited ability to absorb sound and reduce noise.

Existing pickleball paddles may use graphene to strengthen connections between a playing surface and handle, if, for example, the handle and paddle body are constructed as separate pieces. There may be weakness at the connection points of the handle and paddle body with the playing surface. However, using graphene to strengthen connections between a playing surface and handle does not reduce noise generated at the playing surface of the paddle. Instead, introducing further rigidity may worsen sound generation.

Existing pickleball paddles may attempt to reduce sound by introducing construction features. For example, pickleball paddles may have an edge or cap secured or bonded or glued along the circumference of the paddle head. Such construction features may control vibrations to a certain extent, however, do not resolve the source of the sound. The key source of sound comes from during play when a paddle makes contact with a ball, which typically occurs at the playing surface of the paddle. As such, an edge construction feature does provide any solution to modifying or reducing sound generation from the actual playing surface.

Existing pickleball paddles may attempt to reduce sound by introducing elastomeric or foam materials. For example, pickleball paddles may have a core made of an elastomeric or foam material that attempts to reduce sound. In other examples, pickleball paddles may have an edge around the perimeter of the head portion that is made of an elastomeric or foam material. However, such materials only act to dampen the generated sound, but does not address reduction of sound generation from the playing surface of paddles. Furthermore, using certain materials (to e.g., reduce noise) as cores of a paddle may impact game play, such as by increasing or introducing a trampoline effect. Certain cores of a paddle may not be suitable for professional play given that the paddle must adhere to rules of professional associations that may not permit such paddle cores.

### Sound Modification.

Key factors for pickleball paddle design include: weight, size, thickness, stiffness, a soft touch upon impact with the ball, ability to transfer sufficient power to drive the ball cross-court with speed, control and precision. For example, thickness of the paddle results in the ball having greater dwell time or sit time on the surface of the paddle, which is described in the art as a “trampoline effect”. As the ball nestles into the surface it can then bounce off the surface. Hence, modifications to the paddle should not increase or introduce the trampoline effect. Professional associations may have rules that govern paddle requirements to be approved for professional game play. Modifications to the paddle that impact game play (e.g., by increasing or introducing the trampoline effect) may not be approved for professional game play.

Embodiments described herein provide improved pickleball paddles that minimize noise when playing by reducing the sound generated when a ball strikes the pickleball paddle. In some embodiments, the modifications reduce the decibel sound or loudness of a ball striking the pickleball paddle. In some embodiments, the modifications eliminate the sound of a ball striking the pickleball paddle. In some embodiments, the modifications dampen the sound of a ball striking the pickleball paddle. In some embodiments, the modifications change the sound of a ball striking the pickleball paddle. In some embodiments, the modifications change the frequency sound of a ball striking the pickleball paddle. In one embodiment, the frequency sound of a ball striking the pickleball paddle is reduced from about 1200 hz to 1000-500 hz, 800-500 hz, 800 hz or lower, 700 hz or lower, 600 hz or lower, about 500 hz, about 400-500 hz.

In particular, embodiments described herein provide pickleball paddles with modifications that simultaneously alters sound and dampen vibrations. The modified paddles may still be suitable for professional game play.

In addition to providing the desired sound alterations, the modifications described here do not alter performance in order to avoid any play advantage and to permit approval for tournament or professional game play by different associations. For example, the modifications described herein avoid introducing additional spin to the ball, or increasing trampoline effect. Introducing modifications that provide desired sound alteration without introducing added play benefits (i.e. increasing spin or bounce) is key to meeting equipment standards for professional players. Professional pickleball associations, such as USA pickleball, establishes and regulates pickleball equipment industry standards for competitions and professional play. The pickleball paddles disclosed herein having sound alteration qualities have received official certification and approval for official tournaments, leagues, and event play (see https://equipment.usapickleball.org/paddle-list/).

Given the strict playing requirements, existing pickleball paddles have avoided introducing softer or elastic materials as it would increase spin or bounce. In addition, existing pickleball paddles have avoided using fabric-based materials on the playing surface of the paddle given its low durability despite the sound dampening qualities of fabric. Embodiments described herein provide a pickleball paddle for reducing the loudness and/or frequency of sound generated when a ball strikes the pickleball paddle. The paddle has a playing surface with a acoustic layer comprised of woven or non-woven fabric. To enhance the durability of the fabric acoustic layer while maintaining and/or enhancing its sound dampening qualities such that it can be applied to a pickleball paddle, the present inventors have developed a reinforced fabric acoustic layer comprising woven or non-woven fabric and a durability enhancing agent.

Embodiments described herein provide a pickleball paddle for reducing the loudness and/or frequency of sound generated when a ball strikes the pickleball paddle. The paddle has a playing surface with a graphene infused acoustic layer. The graphene infused acoustic layer comprises a graphene infused woven or non-woven fabric comprising graphene and optionally at least one polymer. In some embodiments, the graphene infused fabric has a particular content of graphene, such as between about 1% to 25% graphene by weight. In some embodiments, the graphene infused fabric is applied on the playing surface of the paddle. The graphene infused fabric can be integrated with the playing surface of the paddle.

During play, the pickle ball makes contact with the playing surface. That is, the playing surface is the (visible) paddle area that makes contact with the ball during play. The playing surface can be the two sides of the paddle face that make contact with the ball. The playing surface may also be referred to as the paddle face or hitting surface. A pickleball paddle has an exterior or outside paddle surface and also has an interior or inside paddle core. The graphene infused fabric can be part of the exterior or outside paddle surface to provide a graphene infused acoustic layer for the paddle. Embodiments of the pickleball paddle described herein includes a handle portion and a head portion. In some embodiments, the head and handle portions are molded or formed together as an integral piece. In other embodiments, the head and handle portions are separately formed and attached together. The head portion comprises two opposite surfaces, which can be referred to as playing surfaces. In some embodiments, the head comprises the playing surface. As used herein, a “surface” of the pickleball paddle refers to the face of the head portion of the pickleball paddle which makes contact with and/or for hitting a ball during play. In some embodiments, the surface which makes contact with the ball is the playing surface. In some embodiments, the playing surface is a hitting surface. In some embodiments, the paddle has a surface of a graphene infused acoustic layer or fabric. In some embodiments, a graphene infused acoustic layer is applied onto the surface. A pickleball paddle comprises a core between the opposite surfaces. For example, the core can be between two layers or the two opposing surfaces, respectively. In some embodiments, the core is sandwiched between the outer layers. In some embodiments where the head and handle portions form an integral piece, the core extends down from the head portion to the handle portion between the two opposite surfaces or layers. In some embodiments where the head and handle portions are separately formed, only the head portion has a middle core or both the head and the handle portion may independently have a middle core. In some embodiments, a pickleball paddle has a plurality of layers. The core can be disposed in the middle or between any two layers in a multi-layer pickleball paddle. Where a plurality layers are present, the playing surface is the outer layers of the plurality of layers. In some embodiments, the acoustic layer is the outer layer. In some embodiments, the acoustic layer is a layer of the plurality of layers. The perimeter of the head portion of the pickleball paddles comprises an edge. In some embodiments, the edge comprises a graphene infused acoustic layer. In some embodiments, a graphene infused acoustic layer is applied along a length of the edge.

### Acoustic Surface.

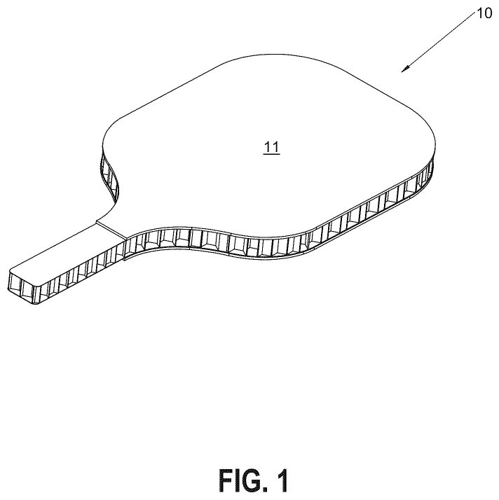

Turning to FIG. 1, a paddle 10 is shown with an acoustic surface layer 11. In some embodiments, an acoustic surface comprises a layer introduced on the striking surface of the paddle. The acoustic layer covers the two sides or two faces of paddle 10. As shown in FIG. 1 and as used herein the term “layer” refers to a material having at least one generally flat plane and a thickness. The thickness of the acoustic layer contributes to dampening of sound generated when a ball strikes the playing surface of the paddle. As shown in FIG. 1 and as used herein, the term “surface layer” refers to a layer where one side or plane of the layer is exposed, acting as the playing surface of the paddle. In some embodiments, an acoustic surface is introduced as a subsurface layer between the playing surface and the paddle core. In some embodiments, an acoustic surface layer is introduced on the playing surface of the paddle and also as a subsurface between the playing surface and the paddle core. Where a pickleball paddle has a plurality of layers, the acoustic layer is the outer layer. In some embodiments, the acoustic layer has a coating or cover or skin. In some embodiments, the acoustic layer is a layer of the plurality of layers. In some embodiments, the playing surface has an outer face plate, wherein the acoustic layer is applied on the outer face plate.

The head of the paddle 10 has a width and a height. The acoustic layer covers the entire width and height of the head. In some embodiments, the acoustic layer provides an outer surface of the playing surface. In some embodiments, the acoustic layer provides a sound reducing layer.

In some embodiments, a pickleball paddle for reducing the loudness and/or frequency of sound generated when a ball strikes the pickleball paddle is provided, wherein the paddle comprises a playing surface. The playing surface comprises an acoustic surface, such as a graphene infused acoustic layer. In some embodiments, the paddle core is sandwiched between two graphene infused acoustic layers which form the playing surface of the paddle. In some embodiments, a graphene infused acoustic layer is applied onto the playing surface of the paddle. In some embodiments, the acoustic layer has a coating or cover or skin.

The acoustic surface reduces or avoids the trampoline effect. The acoustic surface layer may be made of an acoustic pad, foam, fabric, or combinations thereof. In preferred embodiments, the acoustic surface layer is made of acoustic fabrics (such as woven or non-woven fabric). In some embodiments, a fabric acoustic layer comprises woven or non-woven fabric and a durability enhancing agent. Exemplary durability enhancing agent includes but are not limited to a carbon-based material (i.e., graphene, graphite, carbon fibre), a metal fibre, a polymer fibre, Kevlar fibre, fibreglass. In one embodiment, the fabric acoustic layer comprises woven or non-woven fabric and graphene, where graphene adds to the durability and/or resilience of the fabric.

When a pickleball paddle makes contact with the ball, it generates a vibrational wave that travels through the material of the paddle, which subsequently produces sound (or paddle “pop”). The addition of an acoustic surface, such as a material with viscoelastic properties, introduces damping to this process. The viscoelastic material converts vibrational energy into heat, diminishing the amplitude of sound waves and thereby reducing the perceived noise level. The acoustic surface described herein dissipates vibrational energy, preventing it from being fully converted into sound waves, which reduces the noise generated upon ball impact. By absorbing some of the impact energy, the acoustic surface also reduces the overall vibration transferred to the player's hand, enhancing comfort and potentially reducing the risk of injury from repetitive shocks. The fact that the playing experience remains largely unaltered, despite the addition of a new layer, suggests that the mechanical impedance of the paddle (its resistance to vibrational energy transfer) remains balanced. This ensures that the kinetic energy from the player is efficiently transferred to the ball, maintaining the paddle's performance characteristics. The acoustic surface described herein also improves ball control. This improvement may stem from the modified elastic modulus of the paddle due to the additional layer. The viscoelastic nature of the acoustic surface subtly alter the rebound characteristics of the paddle, in some cases providing players with a slightly different, yet potentially advantageous, ball response and control.

In some embodiments, the acoustic layer is infused with graphene. In some embodiments, the acoustic layer is removably applied to the paddle surface. The present inventors have discovered that a graphene infused paddle surface surprisingly also reduces vibration. The lower the vibration on the paddle, the lesser the vibration travels down to a user's arm, thereby reducing impact when striking the ball and reducing the risk of elbow pain. The graphene infused acoustic layer also adds durability, extending the material lifespan of the paddle thereby reducing waste. Addition of graphene also increases the stiffness of the acoustic layer and/or the paddle. In one embodiment, the pickleball paddle is applied with a graphene infused felt on one or both sides of the paddle. In further embodiments, the pickleball paddle is applied with a graphene infused felt along at least a portion of the edge or perimeter of the paddle striking surface. In one embodiment, the pickleball paddle is applied with a graphene infused fabric on one or both sides of the paddle. In further embodiments, the pickleball paddle is applied with a graphene infused fabric along at least a portion of the edge or perimeter of the paddle striking surface.

In some embodiments, the graphene infused felt is detachable or replaceable, such that new graphene infused felt can be applied to the paddle or to interchange with graphene infused felts of different thickness. In one embodiment, the graphene infused felt is secured in place by a removable plastic guard around at least a portion of the paddle perimeter. Removal of the plastic guard allows for replacement of the graphene infused felt, with a new felt inserted in place by re-securing the plastic guard.

In some embodiments, the graphene infused fabric is detachable or replaceable, such that new graphene infused fabric can be applied to the paddle or to interchange with graphene infused fabrics of different thickness. In one embodiment, the graphene infused fabric is secured in place by a removable plastic guard around at least a portion of the paddle perimeter. Removal of the plastic guard allows for replacement of the graphene infused fabric, with a new fabric inserted in place by re-securing the plastic guard.

Graphene is an allotrope of carbon consisting of a single layer of atoms arranged in a two-dimensional hexagonal lattice nanostructure. Given this lattice structure, graphene forms a two-dimensional crystal and is known as the building block for other carbon allotropes, including graphite, carbon nanotubes, and fullerenes. On the other hand, graphite is a naturally occurring form of carbon where the carbon atoms are arranged in a crystalline structure with layers of carbon atom planes, known as graphene layers, stacked one atop another. Each layer is bonded through weak van der Waals forces, allowing them to slide over one another, which is why graphite is often used as a lubricant.

In terms of properties, graphene is transparent and extremely strong. Graphene has been known as the hardest or strongest material known to exist, being about 200 stronger than steel. Given that graphene has the thickness of just one layer of atoms, graphene is incredibly lightweight and thin. Graphene is a very useful nanomaterial due to its exceptionally high tensile strength or high flexibility, electrical conductivity, transparency, and being the thinnest two-dimensional material in the world. It conducts electricity better than graphite and has very high thermal conductivity. Graphene is almost entirely impermeable to gases and liquids. On the other hand, graphite is opaque and has a metallic luster. Graphite is a good conductor of electricity due to the mobility of electrons within its layers, but less conductive than graphene. Given that graphite is soft and slippery, it is useful as a dry lubricant and in pencil lead.

In terms of production, graphene can be produced by mechanical exfoliation (peeling off layers using tape), chemical vapor deposition (CVD), and other methods like reducing graphene oxide. Graphite is mined from the earth and is also produced synthetically from carbon precursors, such as petroleum coke and coal tar.

Graphite has been a commonly used material for centuries. Its applications include use in manufacture of refractory products (i.e., linings for high-temperature equipment), in batteries, in the production of steel as a recarburizing agent, in pencils, and as a lubricant in industries. On the other hand, graphene was discovered in 2004 and its unique properties are currently investigated in a number of potential applications. The present inventors have developed a paddle utilizing graphene for sound reduction.

In some embodiments, an acoustic fabric is made of graphene and polymer fibers, such as one or both of nylon and polypropylene. As used herein, polymer fibers include synthetic and non-synthetic or natural fiber. In some embodiments, an acoustic fabric is made of graphene, nylon, and polypropylene. Introducing nylon has an added benefit of reducing stretch, thereby reducing warping or stretching of the acoustic fabric over time. In one embodiment, an acoustic fabric is made of graphene, N66, and polypropylene. In one embodiment, an acoustic fabric is made of graphene, N66, and polypropylene in approximately 1:5:3 ratio. In one embodiment, the acoustic fabric comprises between about 5-15%, about 7-13%, about 8-12%, about 9-11%, or about 10% graphene. In one embodiment, the acoustic fabric comprises about 25-75%, about 40-60%, about 50-60%, about 50%, or about 55% N66. In one embodiment, the acoustic fabric comprises about 25-50%, about 30-40%, about one third, or about 35% polypropylene. In some embodiments, an acoustic fabric further comprises one or more waterproofing or water-resistant additives. Ranges provided herein includes the endpoints. (See U.S. provisional application No. 63/644,019 filed on May 8, 2024 titled FABRIC, the entire content of which is incorporated herein by reference.)

In some embodiment, a graphene infused fabric comprises by weight between about 1%-25%, preferably about 3-15%, preferably about 5-15%, more preferably about 7-12% graphene. Ranges provided herein includes the endpoints. If the graphene content of the fabric is too low, the fabric is at risk of deteriorating after repeated use. However, if the graphene content of the fabric is too high, the pickleball paddle becomes too heavy for use. In some embodiments, the core layer is at least 10-15 mm thick. In one embodiment, the core layer is 13 mm thick. In some embodiments, the graphene infused fabric layer is 1.5 mm to 5 mm thick, preferably 1.5-3 mm thick. Where a thinner core layer is provided, a thicker graphene infused fabric layer may be used, and vice versa. For example, a pickleball paddle having 10 mm thick core a 4 mm thick graphene infused fabric layer is used on each side. As such, the thickness of graphene infused fabric layer needed is inversely proportional to the thickness of the core.

In some embodiments, the graphene is introduced into the N66 as a very fine powder. In some embodiments, the graphene powder is a white graphene powder. In one embodiment, the graphene powder is a graphene oxide powder.

The graphene infused acoustic fabric manufactured such that the internal structure of the fabric is porous enough to capture, trap, and dissipate sound energy as heat. The surface of the fabric repels liquids, and when including the material into the paddle assembly, the assembly as a whole returns an adequate amount of kinetic energy when impacting a standard ball.

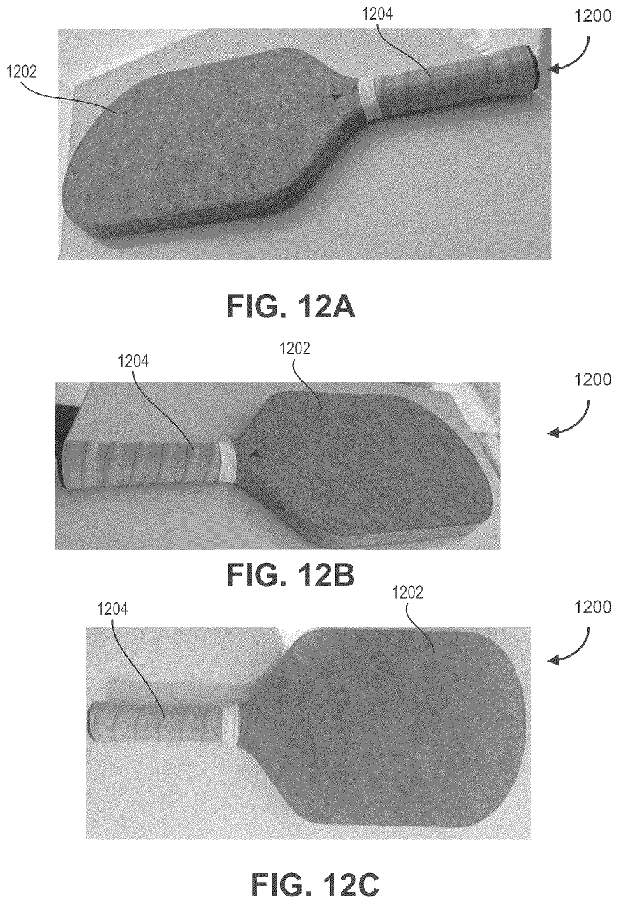

FIG. 12A shows a perspective view of a pickleball paddle 1200, according to some embodiments. FIG. 12B shows a top view of a pickleball paddle 1200, according to some embodiments. FIG. 12C shows another perspective view of a pickleball paddle 1200, according to some embodiments. The pickleball paddle 1200 comprise a paddle head portion 1202, and a handle portion 1204. The paddle 1200 may comprise a honeycomb core or a solid core sandwiched between two striking surfaces. The opposing surfaces of the paddle 1200 comprise a graphene infused acoustic fabric. A noise-reduction fabric edge 1208 of the paddle 1200 extends around the perimeter of the head portion, starting from the one side of the paddle neck (where the head portion meets the handle portion), wrapping around the side of the playing surface and extends down to the other side of the paddle neck. The noise-reduction fabric edge 1208 has a width and comprises a graphene infused acoustic fabric. The graphene infused acoustic fabric may be a graphene infused material that is applied to the striking surface, or comprises the striking surface.

In one embodiment, a pickleball paddle for reducing the loudness and/or frequency of sound generated when a ball strikes the pickleball paddle is provided, the pickleball paddle having a head portion, a handle portion, and an edge having a width, the edge extending from one side of the paddle around the head portion to an opposite side of the paddle. Wherein the paddle comprises a playing surface with a graphene infused acoustic layer, wherein the graphene infused acoustic layer comprises a sheet of graphene infused fabric having a thickness and comprised of graphene and optionally at least one polymer, wherein the graphene infused fabric comprises between about 1% to 25% graphene by weight. Wherein the edge further comprises a graphene infused acoustic layer forming or applied to the width of the edge. In one embodiment, the playing surface graphene infused acoustic layer is integral with the edge graphene infused acoustic layer. In another embodiment, the playing surface graphene infused acoustic layer overlaps with the edge graphene infused acoustic layer.

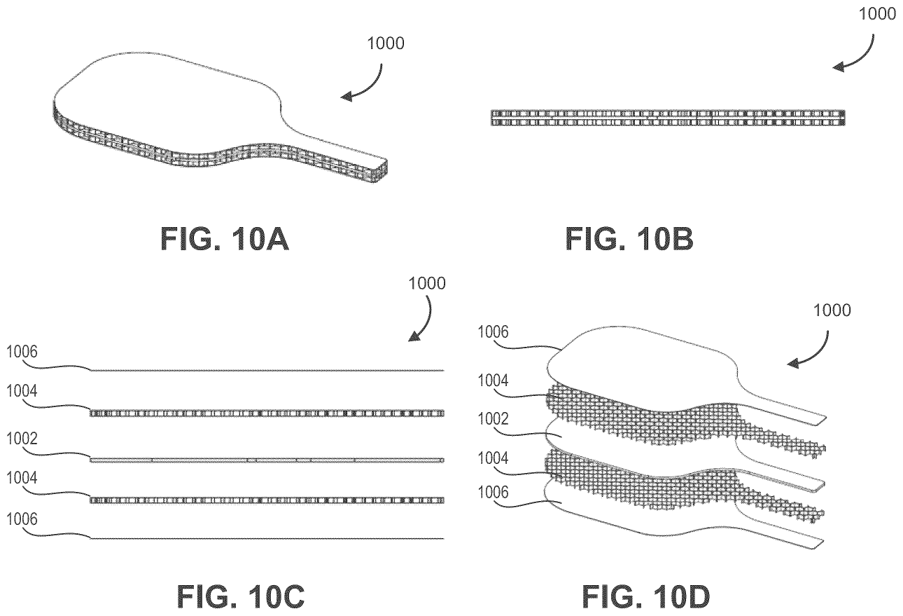

In some embodiments, noise-reduction fabric may be sandwiched between two halves of the honeycomb paddle, or alternatively between two layers of core material. Referring to FIG. 10A-10D, a pickleball paddle 1000 having a middle noise-reduction fabric layer 1002 (such as the graphene infused fabric described herein) between two outer honeycomb layers 1004 is shown. In such an implementation, the noise-reduction fabric layer 1002 may be disposed in the center of the paddle 1000, in addition to or alternatively to playing or striking surfaces comprising the an exterior noise-reduction fabric layer. The noise-reduction fabric layer 1002 extends to the handle portion of the paddle. In alternative embodiments, such as where the head portion and handle portions are formed separately, the noise-reduction fabric layer 1002 does not extend to the handle portion. Around the central noise-reduction fabric layer 1002, two honeycomb halves 1004 may be provided, or alternatively between two layers of core material. On the exterior sides of the honeycomb halves 1004, hard face layers 1006 may be provided to serve as the striking surface. The hard face layers 1006 may comprise a graphene infused fabric.

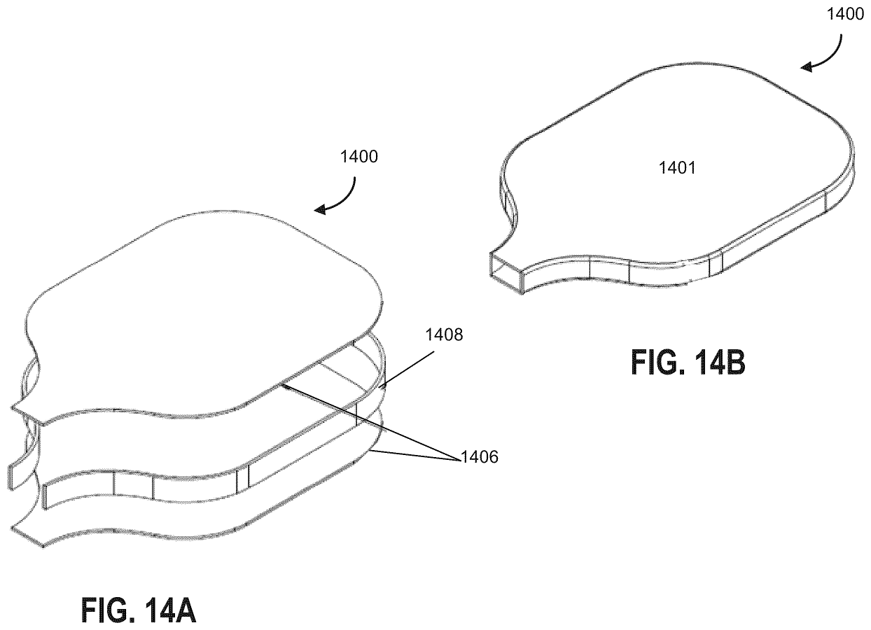

In some embodiments, acoustic fabric is applied to create a shell or encasing around the paddle. Referring to FIG. 14A-14B, a pickleball paddle 1400 having an acoustic fabric shell 1401 is shown for encasing around the honeycomb core. In such an implementation, in one embodiment, the acoustic fabric shell comprises a noise-reduction fabric edge 1408 and two noise-reduction fabric faces 1406 formed into a sealed pocket to encase the paddle or the honeycomb core. As shown, the acoustic fabric shell 1401 may not extend down through the handle as no ball is expected to contact the handle during standard play. This may save on materials used. In some embodiments, the acoustic fabric shell 1401 may extend to the handle (for example, to reduce manufacturing complexity). The acoustic fabric shell aids the paddle assembly in dissipating kinetic energy into heat by constricting airflow, thus reducing the overall sound levels of a ball hitting the paddle surface. In some embodiments, to form the acoustic fabric shell, acoustic fabric is first glued to the honeycomb core and overlapping fabric is glued together forming a seam. Preferably, the seam is formed along the edge of the paddle. To create this edge seam, both heat and pressure are simultaneously applied to create a uniform edge seam.

In one embodiment, a pickleball paddle for reducing the loudness and/or frequency of sound generated when a ball strikes the pickleball paddle is provided, the pickleball paddle having a head portion, a handle portion, and an edge having a width, the edge extending from one side of the paddle around the head portion to an opposite side of the paddle. Wherein the paddle comprises two opposing playing surfaces, and wherein the edge and the two opposing playing surfaces comprise a graphene infused acoustic shell, wherein the graphene infused acoustic shell comprises a graphene infused fabric of graphene and optionally at least one polymer, wherein the graphene infused fabric comprises between about 1% to 25% graphene by weight. In one embodiment, the graphene infused acoustic shell is a single integral unit. In another embodiment, the graphene infused acoustic shell comprises two shell surfaces comprising the two opposing playing surfaces, and a length of perimeter shell piece comprising the pickleball edge, wherein the two shell surfaces and the length of perimeter shell are bonded together to form the graphene infused acoustic shell.

USA pickleball has recognized that embodiments described herein for a pickleball paddle having an acoustic fabric shell as disclosed herein as being the first fabric paddle to receive official certification and approval for official tournaments, leagues, and event play. This embodiment of the paddle is the first fabric paddle having sound alteration qualities to be introduced to USA pickleball.

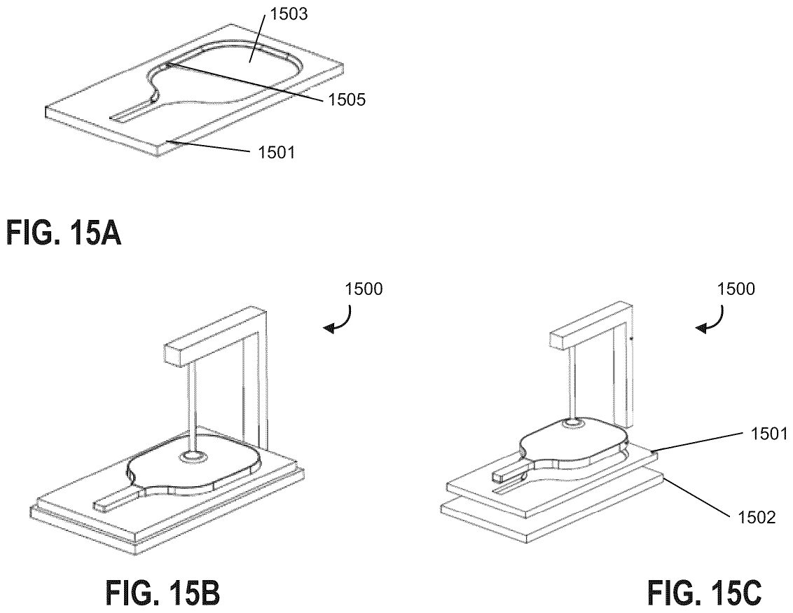

Embodiments described herein include a tool for the creation of the acoustic fabric shell, which allows for the creation of an uniform edge seam. In some embodiments, the tool comprises one or two metal plates containing a controlled heating element and which are shaped into a desired profile of the formed edge. Referring to FIG. 15A, a metal heat sealing plate 1501 is shown having an aperture 1503 shaped to match the profile of a pickleball paddle. In such an implementation, the aperture 1503 has a perimeter 1505 machined to the desired profile of the pickleball paddle edge. Referring to FIG. 15B-15C, a tool assembly 1500 is shown where the pickleball paddle is applied to the metal heat sealing plate 1501 and pressure is applied. The pressure may be applied by hand, by manual mechanical means, or by automated mechanical means. In such an implementation, a second heating plate 1502 is provided for additional heat. In some embodiments, the second heating plate is temperature controlled. The heat and pressure work to seal the edge seam and form the fabric into a consistent profile.

In some embodiments, the noise-reduction fabric may be manufactured from graphene products (such as the graphene-containing acoustic fabric described herein) or manufactured to incorporate graphene. In some embodiments, the paddle may be covered in a thin film of carbon applied to make the paddle more compatible with conventional printing processes (e.g., the carbon layer is capable of attaching to the ink from printing more strongly than the paddle would be without this layer).

In some embodiments, a thin layer of liquid silicone may be applied to a board which may achieve noise reduction.

### Carbon Fiber.

In some embodiments, a carbon fiber board may be implemented with the pickleball paddle. Carbon fiber is a material that comprises fiber made mostly of carbon atoms. Carbon fibers may also be implemented in combination with other materials to form a composite. Carbon fiber boards may be fabricated by bonding multiple layers of carbon fiber fabric together. For example, the carbon fiber boards may comprise three layers of carbon fiber fabric bonded together. The resulting board may be a relatively stiff carbon fiber board.

In some embodiments, a graphene-infused fabric is laminated onto a carbon fiber layer to create a composite. In some embodiments, acoustic fabric (such as a graphene-infused fabric) may be adhered to a carbon fiber board on the surface of the paddle and/or on a honeycomb core. In some embodiments, the paddle may comprise a central honeycomb core over which a thin layer of non-woven fabric is applied. Over this non-woven fabric a carbon fiber board may be applied. Over top of the carbon fiber board, acoustic fabric (e.g., a graphene infused fabric) can be applied. In other embodiments, a carbon fiber strip layer is first adhered to the honeycomb core, and then the acoustic fabric (such as a graphene-infused fabric) is applied to the carbon fiber strip layer.

In some embodiments, the carbon fiber board can be disposed on the outside of the noise-reduction fabric. In some embodiments, the acoustic fabric (e.g., a graphene infused fabric) is beneath the carbon fiber board. In such embodiments, the noise-reduction fabric may not need to be abrasion-resistant or waterproof. Such embodiments may still provide paddles that exhibit sturdiness and may be painted with conventional printing materials.

Combining the acoustic fabric with the carbon fiber layer into a composite creates a more impact and puncture resistant playing surface or edge than just the acoustic fabric or just the carbon fiber layer alone. In addition stability and rigidity of the entire paddle assembly is improved.

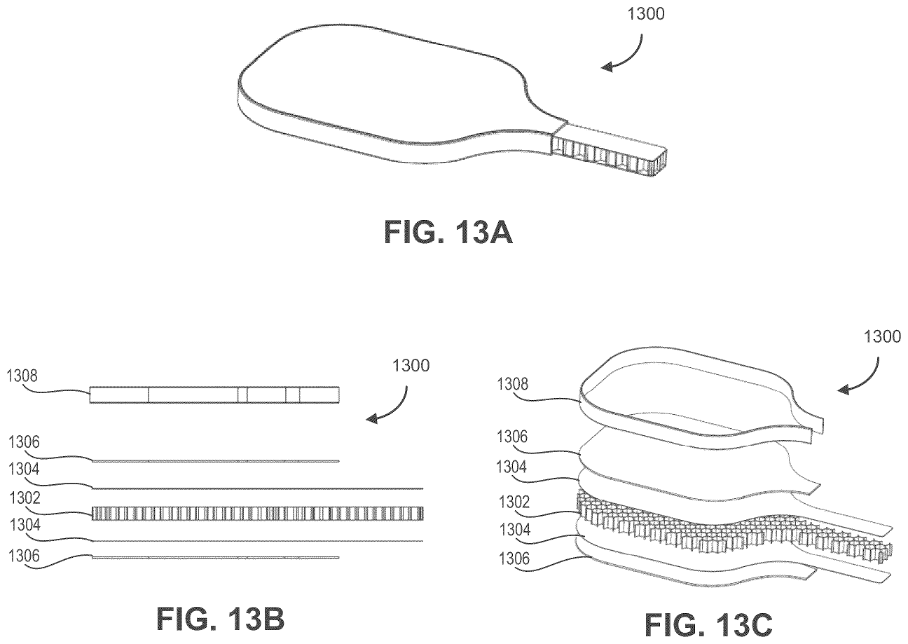

In some embodiments, noise-reduction fabric may be disposed on the outside of the paddle. Referring to FIG. 13A-13C, a pickleball paddle 1300 having external noise-reduction fabric layers 1306 on the exterior playing surface of the paddle 1300. In such an implementation, the honeycomb core layer 1302 may be disposed in the center of the paddle 1300. On either side the honeycomb core layer 1302, two hard face layers 1304 may be provided. A hard face layer can be made from carbon fibre/epoxy or graphite/epoxy composite. On the opposing exterior sides of the two hard face layers 1304, noise-reduction fabric layers 1306 may be applied. As shown, the noise-reduction fabric layers 1306 do not extend down to the handle portion as no ball is expected to contact the handle during standard play. This may save on materials used. In some embodiments, the noise-reduction fabric layers 1306 may extend to the handle (for example, to reduce manufacturing complexity). Surrounding the handle portion of the paddle 1300, an edge guard extends from one side of the paddle around the head portion to an opposite side of the paddle. The edge guard has a width that is wider than the thickness of the paddle 1300, such that one or both sides of the edge guard folds over the rim of the head portion onto the playing surface, thereby encapsulating all the layers, and the edge guard comprises a noise-reduction fabric edge 1308. The noise-reduction fabric edge 1308 comprises the graphene infused fabric disclosed herein and can act as a guard to protect the noise-reduction fabric layers 1306 and also keeping them in place.

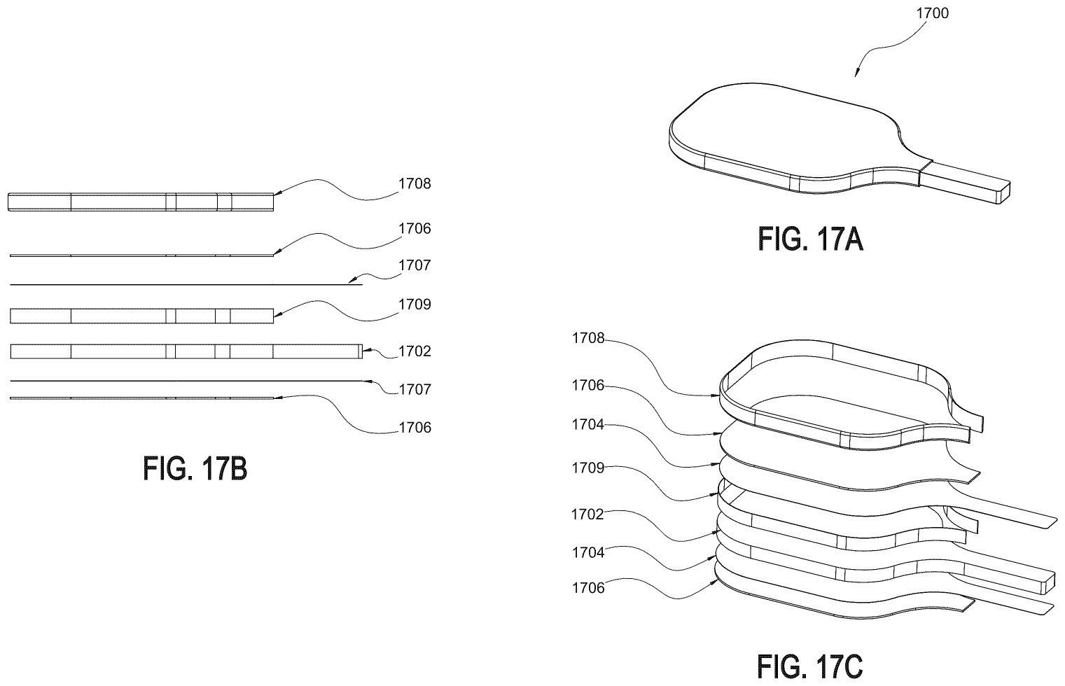

Referring to FIGS. 17A-17C, a pickleball paddle 1700 having external noise-reduction fabric layers 1706 on the exterior playing surface of the paddle 1700. A core layer 1702 may be disposed in the center of the paddle 1700. On either side of the solid core layer 1702, two hard face layers 1704 may be provided. On the opposing exterior sides of the two hard face layers 1704, noise-reduction fabric layers 1706 may be applied. As shown, the noise-reduction fabric layers 1706 optionally do not extend down to the handle portion. In some embodiments, the noise-reduction fabric layers 1706 may extend to the handle (for example, to reduce manufacturing complexity). Surrounding the handle portion of the paddle 1700, an edge guard extends from one side of the paddle around the head portion to an opposite side of the paddle. The edge guard has a width that is wider than the thickness of the paddle 1700, such that one or both sides of the edge guard folds over the rim of the head portion onto the playing surface, thereby encapsulating all the layers. The edge guard comprises a noise-reduction fabric edge 1708. The noise-reduction fabric edge 1708 comprises the graphene infused fabric disclosed herein and can act as a guard to protect the noise-reduction fabric layers 1306 and also keeping them in place. The noise-reduction fabric edge 1708 is further supported by a strip of carbon fiber 1709 disposed underneath the noise-reduction fabric edge 1708 the strip of carbon fiber also extending from one side of the paddle around the head portion to an opposite side of the paddle.

In one embodiment, a pickleball paddle for reducing the loudness and/or frequency of sound generated when a ball strikes the pickleball paddle is provided, the pickleball paddle having a head portion, a handle portion, and an edge having a width, the edge extending from one side of the paddle around the head portion to an opposite side of the paddle. Wherein the head and handle portion of the paddle comprises a middle core layer is disposed or sandwiched between two hard face layers, and a graphene infused acoustic layer is applied to opposing exterior sides of at least the head portion of the two hard face layers. The graphene infused acoustic layer comprises a first graphene infused fabric of graphene and optionally at least one polymer, wherein the graphene infused fabric comprises between about 1% to 25% graphene by weight. The edge comprises an outer layer of a second graphene infused fabric having the same or different graphene content or having the same or different thickness than the first graphene infused fabric, and an inner layer of carbon fiber strip. The width of the edge being wider than the thickness of the pickleball paddle forming an overhang region on one or both sides, wherein the overhang region folds over the rim of the pickleball paddle onto the playing surface to anchor the layers of the paddle together.

Graphene can be used to enhance the material properties of the hard surface layer of the paddle. Such hard layers are traditionally made with only carbon fibre/epoxy or graphite/epoxy composite, but the addition of graphene can result in: extended life, thinner layer, lighter layer, better ‘bounce’, better rigidity, less material usage, etc. In some embodiments, the hard layers disclosed herein comprises graphene infused epoxy composite, such as graphene infused carbon fibre/epoxy or graphite/epoxy composite.

### Edge Variations.

In some embodiments, a pickleball paddle comprises an acoustic fabric edge. The acoustic fabric edge extends around the periphery of the head of the pickleball paddle.

In some embodiments, the paddle may have leading edge serrations. In such embodiments, small serrations may be cut (or otherwise manufactured into) along the perimeter edge of the paddle, extending from one side of the paddle around the head portion to an opposite side of the paddle. Such serrations may be helpful in reducing the noise of the paddle. In some embodiments, these serrations may be applied to paddles with noise-reduction fabrics applied thereto and to paddles without noise-reductions fabrics applied thereto.

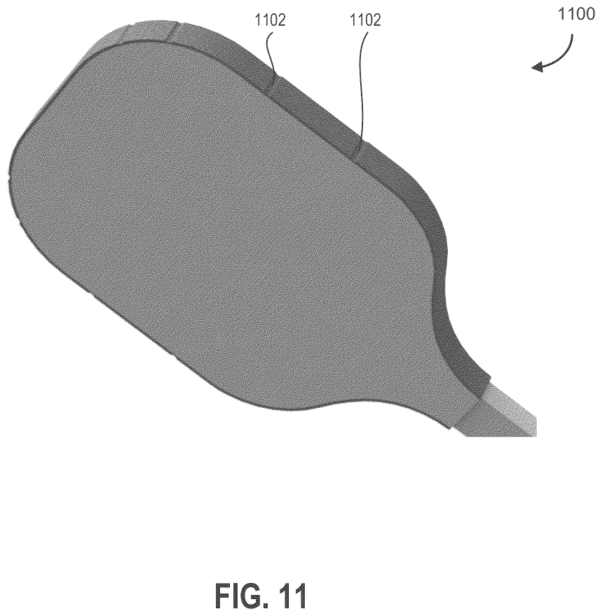

In some embodiments, ridges may be added to the outer profile of the paddle. FIG. 11 shows a pickleball paddle with ridges 1102 added to the perimeter edge of the paddle extending from one side of the paddle around the head portion to an opposite side of the paddle. Paddle 1100 has multiple spaced apart ridges 1102 positioned around at least a portion of the perimeter edge of the paddle, each ridge 1102 extending across the width of the paddle.

In some embodiments, a composite edge guard is provided along at least a portion of the periphery of the playing surface of a paddle. The composite edge guard is comprised of the acoustic fiber-carbon fiber layer composite described herein. Combining the acoustic fabric with a carbon fiber layer into a composite allows for better adhesion of the acoustic fabric to the core assembly, thereby allowing the damping effects of the acoustic fabric edge to be fully realized.

### Sensors.

Graphene conducts electricity even better than graphite and has very high thermal conductivity. By introducing a graphene infused surface to the paddle, this allows for incorporation of wearable technology to the pickleball paddle in addition to sound reduction. For example, wearable technology may be utilized to gather play data or ball impact data. Such data is then processed to analyze player performance.

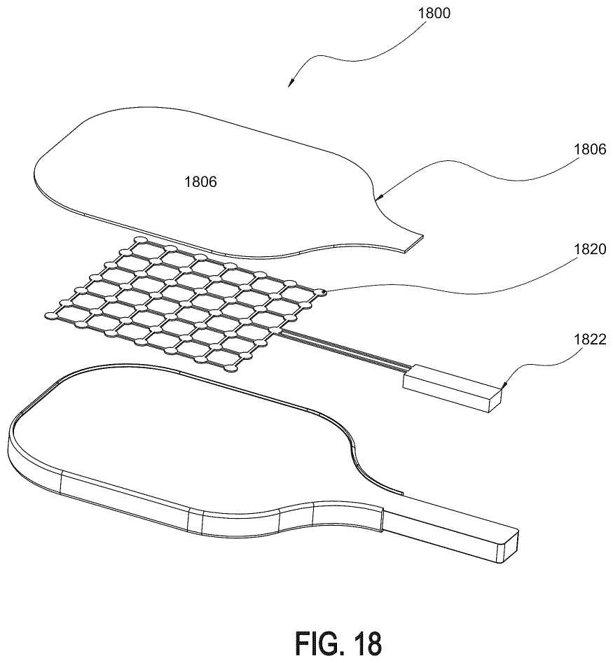

FIG. 18 shows a pickleball paddle 1800, where an electrode grid 1820 is positioned beneath the noise-reduction fabric layer 1806. The noise-reduction fabric layer 1806 comprises a graphene infused fabric layer that is laminated to the electrode grid 1820, such that the graphene infused fabric layer forms a sensor. Alternatively, the graphene infused fabric layer is laminated to a piezoelectric sensor grid to form a graphene enhanced piezoelectric sensor. The graphene infused fabric layer in conjunction with an electrode grid or piezoelectric sensor grid forms a sensor assembly. This sensor assembly is electrically connected to a signal processor and transmitter 1822 located inside the handle portion of the paddle. The signal processor interprets signals generated by the sensor when a ball contacts the fabric. The signal processor transmits as output user-relevant data such as: location of a ball on the paddle, force, speed, spin, direction, dwell, contact area, etc.

### Recessed Inserts.

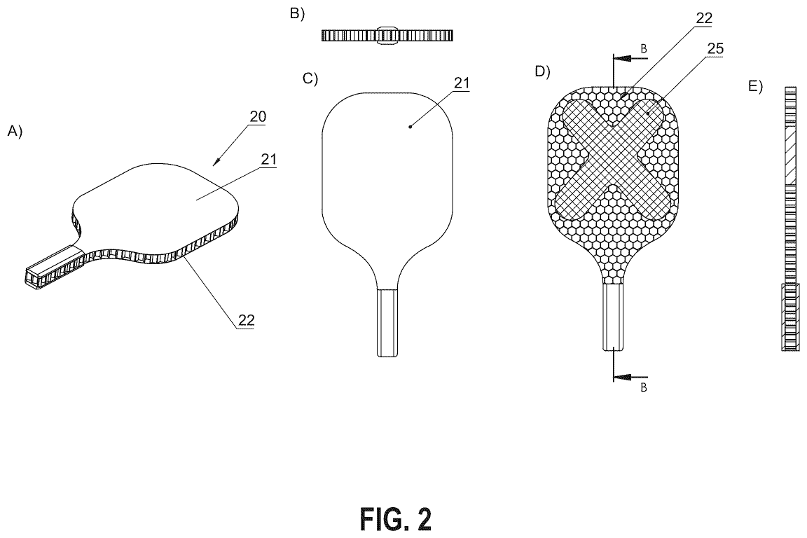

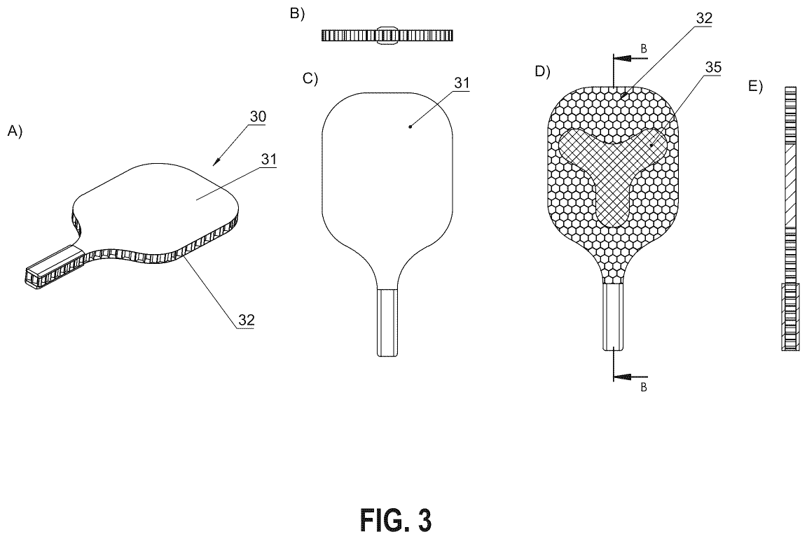

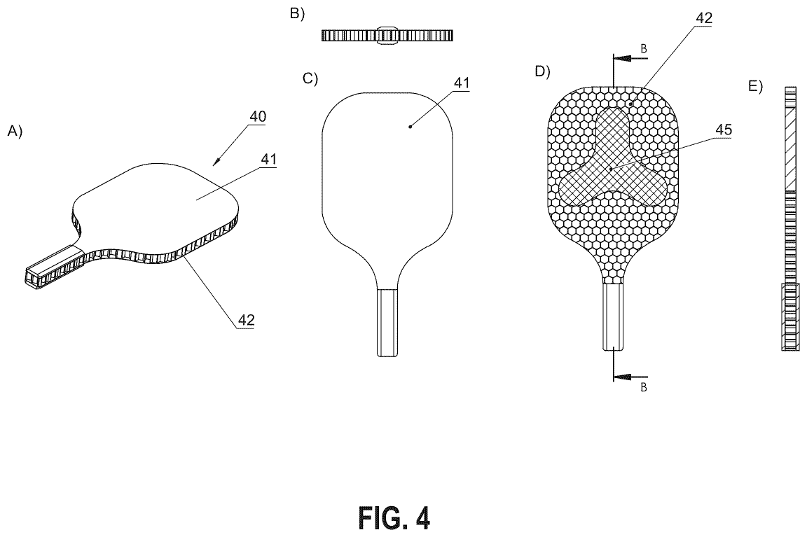

Turning to FIGS. 2-5, paddles 20, 30, 40, 50 with recessed inserts 25, 35, 45, 55 are shown. A recess is introduced into the core 22, 32, 42, 52 (for example a honeycomb core) of the paddle by carving out the recess from the core or manufacturing the core with a recessed area defined in the core structure pattern. The core with the recessed inserts is covered by the outer playing surface layer 21, 31, 41, 51. In some embodiments, the recess has a depth extending partially through the thickness of the core. For example, the recess has a depth of about 5%, about 10%, about 15%, about 20%, about 25%, about 30%, about 35%, about 40%, about 45%, or about 50% of the thickness of the core. In one embodiment, the recess has a depth extending through the thickness of the core. The recess is filled with an insert made of rubber, Polyvinyl chloride (PVC), foam, or combinations thereof. These recessed inserts controls acoustics, while also providing strength to brace the paddle.

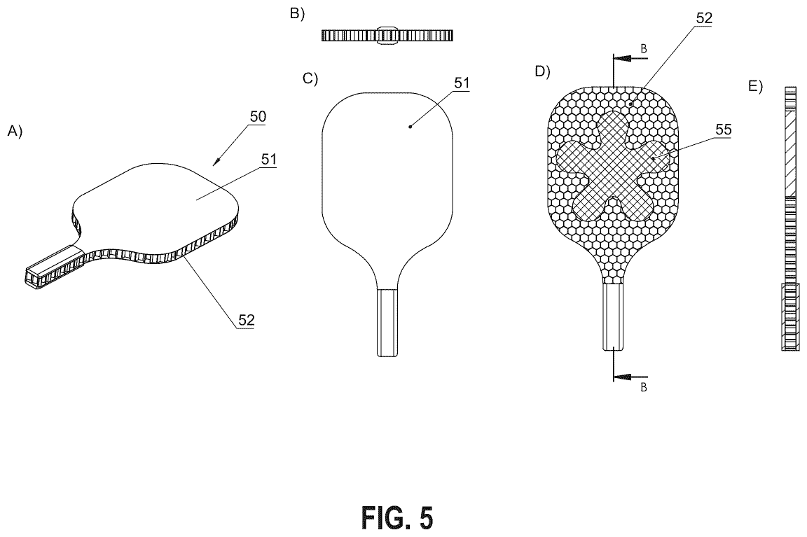

The shape of the recessed inserts impacts the sound generated when a ball strikes the pickleball paddle. Air inside the paddle migrates the sound to the sides and corners of the paddle from where the sound exits. Altering the flex of the paddle also changes the sound. The present inventors have discovered that recessed inserts having a radiating shape decreases the sound produced when a ball strikes the paddle. Example radiating shape include, a X-shaped recessed insert 25, a Y-shaped recessed insert 35, or a A-shaped recessed insert 45. The recessed inserts may comprise one or more pieces so long as they form an overall radiating shape, extending from a center point to a plurality of radially outward point (like a star or a flower). In some embodiments, the recessed inserts have a shape comprising 3 or more, 4 or more, 5 or more, 6 or more, 7 or more, or 8 or more points extending from the center of the recessed insert. FIG. 5 shows an exemplary paddle 50, with a 5-point shaped recessed insert 55.

### Weight Distribution.

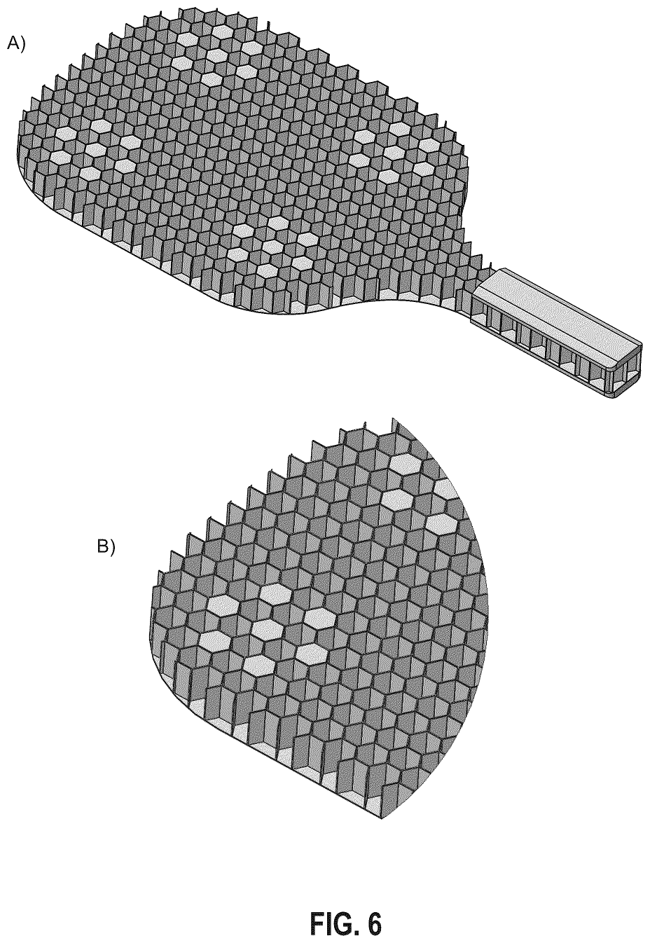

The weight of the pickleball paddle also influences the sound it generates. In particular, non-uniform weight distribution, particularly greater weight near the corners of the paddle, provide improved acoustic control. Providing support or weight also provide a damping effect to the paddle, which is advantageous as it reduces vibrations traveling down the arm during play. As shown in FIG. 6, the honeycomb core is filled with weighted inserts at select locations, to increase weight distribution near the corners. In some embodiment, weighted inserts are position near each corner of the paddle. In some embodiments, the structure of the core is altered with denser patterns (i.e., denser honeycomb) near the corners. In some embodiments, the core has an irregular structural pattern resulting in greater weight near the corners. In some embodiments, non-uniform additional layers are added between the core and the outer playing surface area, with thicker additional layers near the corners. In some embodiments, pieces of additional layers are added near the corners, between the core and the outer playing surface area. In one embodiment, the additional layers are added to one side of the paddle. In one embodiment, the additional layers are added to both sides of the paddle. In some embodiments, the additional layers are made from carbon fiber and/or fibreglass.

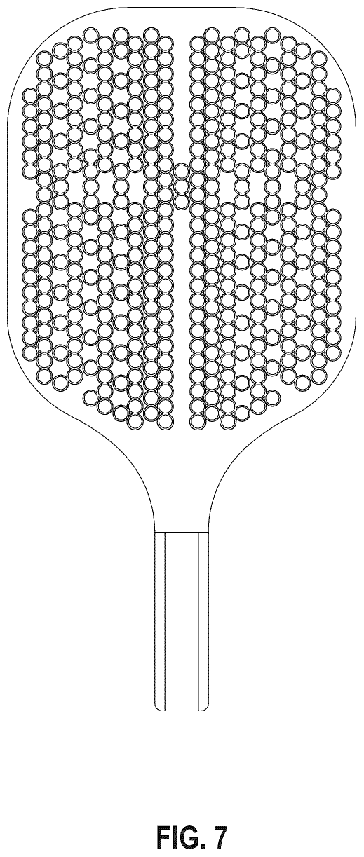

Alternatively, the non-uniform weight distribution is achieved by removing material from the paddle layers or fabricating the paddle layers with hollow spaces. As shown in FIG. 7, the paddle core has a pattern of hollow bores distributed throughout, with fewer bores near the corners and more bores closer to the vertical and horizontal center lines of the paddle. This distribution of bores effectively results in greater weight distribution near the corners. In some embodiments, the paddle core has hollow channels, grooves, and/or irregular shaped spaces near the vertical and horizontal center lines of the paddle to distribute greater weight to the corners.

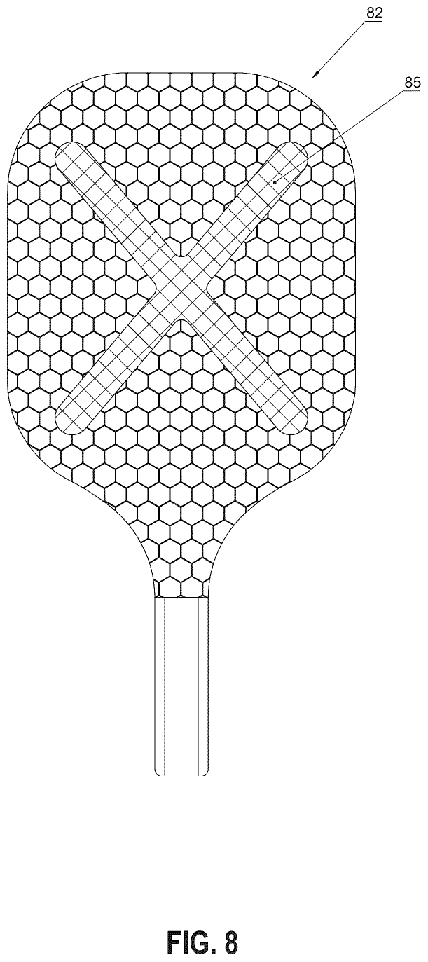

The pickleball paddles described herein may adopt multiple modifications to control noise. For example, FIG. 8 shows paddle core 82 with an X-shaped reinforcement 85. The reinforcement 85 is created by introducing a recessed insert into the core as described herein. The recessed insert is weighted such that greater weight is distributed along the diagonal axes towards the corners of the paddle. In some embodiments, the paddle has a recess without inserts to distribute greater weight near the corners. Such recesses also has a radial shape but along the horizontal and/or vertical axes of the paddle, leaving more materials near the corners of the paddle.

### Core Sound-Proofing.

In some embodiments, the core design may be made of soundproofing material which may block sound transmission and may achieve noise reduction.

### Exemplary Sound Testing.

The following are exemplary results of embodiments according to the present invention. These embodiments are not limiting on the full scope of the present invention, but they merely illustrate particular example embodiments. Nothing in the following is intended to narrow the scope of the concepts described throughout the rest of the description.

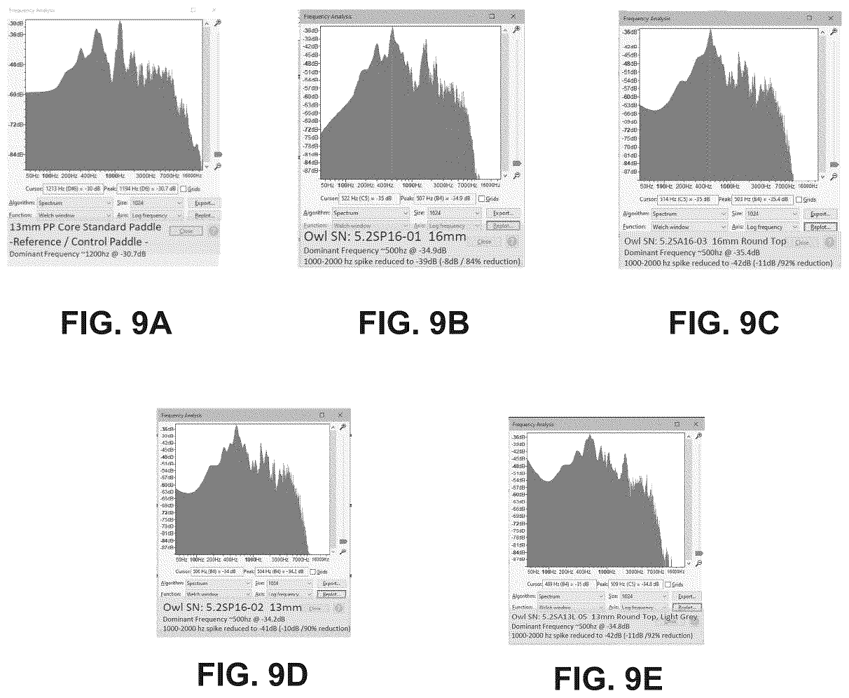

Frequency analysis was conducted on five paddles (see FIGS. 9A-9E): A) Reference/Control Paddle; B) 16 mm cover paddle with cover according to the present invention; C) 16 mm cover paddle with round top with cover according to the present invention; D) 13 mm cover paddle with cover according to the present invention; and E) 13 mm cover paddle with round top with cover according to the present invention.

To measure which frequencies present and relative loudness contained in a sound sample of a pickleball paddle hitting a pickleball of some pickleball paddles and other pickleball paddles designed in accordance with the teachings contained herein, sound testing was performed.

The equipment used included a general purpose omnidirectional microphone Apex850 (frequency response: 80 Hz-12 kHz), Focusrite 2i2 audio interface 48 kHz (Sample Rate 128 Buffer), computer workstation with USB interface, a reference pickleball, a Reference/Control Paddle, and Paddle to be tested (test subject).

The microphone was on a stand at 36 inches above the ground, placed 18 inches away from the center of where the paddle surface was swung and contacted the ball. Audio recording levels were tested and adjusted to make sure no clipping occurred.

The paddle was swung by hand and hit the ball with the power of a strong serve. The first sound readings was a control test using the Reference/Control Paddle which is a 13 mm core standard paddle (see FIG. 9A). It was loud and had a higher frequency ‘pop’ to it. The test paddles (16 mm, 16 mm Round Top, 13 mm, and 13 mm Round Top shown in FIG. 9B, FIG. 9C, FIG. 9D, and FIG. 9E respectively) were recoded into an audio sample using the same swing and ball. Results were recorded using a basic open-source DAW (digital audio workstation) called ‘Audacity’. The sound samples were then inspected using the frequency spectrum analysis tool in the DAW. This tool shows the frequencies and their relative sound pressure levels.

Sound pressure level measurements are taken at the DAW's dBFS and may not represent on-court sound pressure level (SPL).

Referring to FIGS. 9A-9E, the reference paddle A) produces sound with a dominant frequency of ˜1200 hz @−30.7 dB. In contrast, the 16 mm covering paddles B) and C) have a dominant frequency around ˜500 hz @−34.9 dB and −35.4 dB respectively. Furthermore, the 16 mm covering paddles had the 1000-2000 hz spike reduced to −39 dB (−8 dB/84% reduction) and −42 dB (−11 dB/92% reduction) respectively. Furthermore, the 13 mm covering paddles D) and E) have a dominant frequency around ˜500 hz @-34.2 dB and −34.8 dB respectively. Furthermore, the 13 mm covering paddles had the 1000-2000 hz spike reduced to −41 dB (−10 dB/90% reduction) and −42 dB (−11 dB/92% reduction) respectively. This may indicate an 8-11 decibel reduction in the SPL of the specific “annoying” frequency that some pickleball paddles produce. The sound energy may be reduced by 80-90% which may be perceived as a sound that is half as loud.

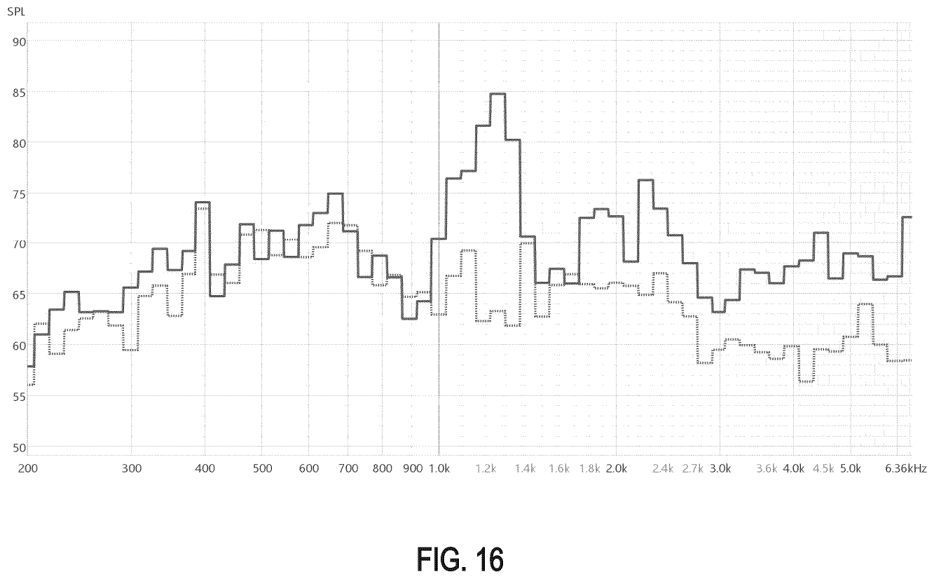

FIG. 16 shows a real time analyzer audio spectrum output test comparing a standard pickleball paddle (Babolat Touch™) compared to the quiet pickleball paddle disclosed herein having the graphene infused fabric layer. Measurements were taken at 5 ft from paddle with calibrated measurement microphone. Data shown is a compilation of 5× overhead smash hits. Franklin X40 ball was used. The standard pickleball paddle yielded a highest sound level of 84.7 dB at 1200 Hz. In comparison, the present quiet pickleball paddle yielded a highest sound level of 73.4 dB at the 400-600 Hz range, which is a 11.3 dB reduction in sound level. Significantly, the quiet paddle also reduced the 1200 hz sound spike by 15-20 dB.

### Exemplary Pickleball Paddles.

By way of an illustrative example, the OWL™ Founder's Edition™ pickleball paddle has a core thickness of 16 mm (0.63 inches), a weight average of 7.9 oz, a handle length of 4.6 inches, a paddle length of 15.8 inches, and a paddle width of 7.9 inches. This paddle is comprised of materials including proprietary Acoustene™ composite, polypropylene honeycomb core, and OWL™ flight grip with a grip circumference of 4.13 inches. Grip sizes for this paddle may vary up to ⅛ inches. This paddle has a woven Acoustene™ edge guard and includes innovative technology that delivers increased performance benefits, less noise, and unprecedented control and touch.

By way of another illustrative example, the OWL™ CX™ pickleball paddle from the OWL™ Control Series™ has a core thickness of 16 mm (0.63 inches), a weight average of 7.9 oz, a handle length of 4.6 inches, a paddle length of 15.8 inches, and a paddle width of 7.9 inches. This paddle has an OWL™ flight grip with a grip circumference of 4.13 inches. Grip sizes for this paddle may vary up to ⅛ inches. The paddle face is Acoustene™ composite, the core material is polypropylene honeycomb, and the edge guard is woven Acoustene™. This paddle is an ultimate control paddle with a huge sweet spot, and delivers unparalleled consistent feel across the entire paddle face. It has a soft feel allowing for easy drops and resets, and is designed for players looking for a soft feel and players capable of creating their own power. This pickleball paddle has a thicker profile allowing for extremely stable feel, allowing for less mishits and delivery of the power needed for players to drive pickleballs.

By way of another illustrative example, the OWL™ CXE™ pickleball paddle from the OWL™ Control Series™ has a core thickness of 16 mm (0.63 inches), a weight average of 7.8 oz, a handle length of 5.0 inches, a paddle length of 16.3 inches, and a paddle width of 7.5 inches. This paddle has an OWL™ flight grip with a grip circumference of 4.13 inches. Grip sizes for this paddle may vary up to ⅛ inches. The paddle face is Acoustene™ composite, the core material is polypropylene honeycomb, and the edge guard is woven Acoustene™. This pickleball paddle is an ultimate control paddle with a huge sweet spot, and delivers unparalleled consistent feel across the entire paddle face. It has a soft feel allowing for easy drops and resets, and is designed for players looking for a soft feel and players capable of creating their own power. This pickleball paddle has a thicker profile allowing for extremely stable feel, allowing for less mishits and delivery of the power needed for players to drive pickleballs.

By way of another illustrative example, the OWL™ PX™ pickleball paddle from the OWL™ Power Series™ has a core thickness of 13 mm (0.51 inches), a weight average of 7.6 oz, a handle length of 4.6 inches, a paddle length of 15.8 inches, and a paddle width of 7.9 inches. This paddle has an OWL™ flight grip with a grip circumference of 4.06 inches. Grip sizes for this paddle may vary up to ⅛ inches. The paddle face is Acoustene™ composite, the core material is polypropylene honeycomb, and the edge guard is woven Acoustene™. This pickleball paddle is a powerful model with a slim core profile, and the thinner profile leads to fast maneuverability. It enables maximum hand speed and is designed for players looking for additional put away power while still maintaining amazing soft feel and control from the Acoustene™ graphene surface of the paddle.

By way of another illustrative example, the OWL™ PXE™ pickleball paddle from the OWL™ Power Series™ has a core thickness of 13 mm (0.51 inches), a weight average of 7.5 oz, a handle length of 5.0 inches, a paddle length of 16.3 inches, and a paddle width of 7.5 inches. This paddle has an OWL™ flight grip with a grip circumference of 4.06 inches. Grip sizes for this paddle may vary up to ⅛ inches. The paddle face is Acoustene™ composite, the core material is polypropylene honeycomb, and the edge guard is woven Acoustene™. This pickleball paddle is a powerful model with a slim core profile, and the thinner profile leads to fast maneuverability. It enables maximum hand speed and is designed for players looking for additional put away power while still maintaining amazing soft feel and control from the Acoustene™ graphene surface of the paddle.

Exemplary pickleball paddles enable quieter play and a quieter experience. These paddles may result in noise reduction, reducing the noise profile, acoustic footprint, and sonic impact of play by 50% or more. These pickleball paddles may have the lowest-in-industry composite frequency and decibel profile on the market. Exemplary pickleball paddles may reduce the distinct staccato ‘pop’ or ‘thwack’ sound the ball makes on impact, and may instead produce a dull ‘thud’ sound. The sounds produced by these paddles may be dampened or muffled. The difference in tone may reduce the distance sound travels. The sound produced by exemplary pickleball paddles may be less alarming or grating to the nervous system. These paddles may deliver a hertz level below 600 and a decibel level below 80 when striking a ball, which is far below the 1,100 to 1,200 hertz and near-harmful decibel range above 85 that industry-standard pickleball paddles register when striking a ball. The noise profile may include an Acoustene™ sheath, which is water resistant. These paddles may provide acoustics-related solutions to sound-sensitive locations. The reduced noise produce by the exemplary paddles may deceive opponents when they react with the expectation of a louder ball strike or make it more difficult for opponents to tell how hard a player has hit a shot. For pickleball instructors, the lower frequency and quieter sound of the frame may make it easier to give instruction and guidance during play without having to shout or repeat instructions. Cutting-edge nano technology materials may be used in paddle components, such as in a graphene/nano technologically-enhanced carbon honeycomb.

Exemplary pickleball paddles include paddles that are certified as qualifying for USA Pickleball™'s QUIET Category. Exemplary pickleball paddles include paddles tested and certified by USA Pickleball™ and approved for all official and sanctioned USA Pickleball™ tournament, league, and event play. These paddles may be part of the Association of Pickleball Players™ official paddle portfolio.

Exemplary pickleball paddle superior playability benefits may include control, spin, power, touch, comfort, consistency, and precision. Spinning the ball, control of ball speed, and control of ball direction may be improved. These paddles may improve volleys, drop shots, ball returns, and resets. Players may have more sensitivity with these paddles. These paddles may have a larger sweet spot for enhanced accuracy for off-center impacts, allowing pinpoint accuracy. No loss of ball speed may occur when using these paddles, and players may not need to alter their swing when using these paddles instead of prior art paddles. Additionally, these paddles may be lightweight and may have an anti-head heavy design for increased balance and effortless maneuverability. 13 mm and 16 mm elongated handle options may be available for these paddles.

As a further example, these paddles may have unique vibration dampening layered construction for arm and elbow comfort which may result in more comfortable play and may reduce elbow and arm pain. In addition, these paddles may improve feel for players. Solid hits from these paddles may produce very little to no vibration in the handle. These paddles may help a player keep the rhythm of their swing when playing. These paddles may enable players of every skill level, from beginner to professional, to play for extended periods of time, during more hours of the day, and in diverse locations. As another benefit, these paddles may instantly improve a player's performance, and may enable players to hit an increased number of cut shots.

Exemplary pickleball paddles may have inside-out engineering built to deliver longer paddle performance and exceptional durability. The surface of these pickleball paddles may be abrasion-resistant, with respect to a ball, and designed to ensure a clean surface at all times for optimal play. These paddles may have a sturdy and comfortable grip.

The paddle grip of the exemplary pickleball paddles may be cleaned with a damp microfiber cloth. The paddle surface may be cleaned with a soft brush.

### Implementation Details and Applications.

The acoustic surfaces described herein, such as the graphene infused acoustic fabric, may be applied to racquet and paddle frame for any sport. For example, racquets and paddles used in badminton, tennis, racquetball, squash, cricket, paddleball, or table tennis.

In alternate embodiments, graphene is infused into the metal or aluminum in the manufacture of racquets.

Although the embodiments have been described in detail, it should be understood that various changes, substitutions and alterations can be made herein. Moreover, the scope of the present application is not intended to be limited to the particular embodiments or examples described in the specification. As can be understood, the examples described above and illustrated are intended to be exemplary only.

For example, the present invention contemplates that any of the features shown in any of the embodiments described herein, may be incorporated with any of the features shown in any of the other embodiments described herein, and still fall within the scope of the present invention.

Embodiments described herein relate to a paddle (such as a pickleball paddle) with improvements to control noise. The paddle can have a graphene infused acoustic layer applied on one or both sides of the paddle. The graphene infused acoustic layer may be a graphene infused fabric. The paddle has a playing surface of graphene infused acoustic fabric, with a particular graphene (particularly graphene powder or graphene oxide) content of the fabric. For example, the content of the fabric can be:
i. about 5-15% graphene, such as 10% graphene;
ii. about 40-60% N66, such as 55% N66;
iii. about 30-40% polypropylene, such as 35% polypropylene.

In some embodiments, the graphene infused acoustic fabric can also have about 1-10% waterproofing or water-resistant additive, such as about 5% waterproofing or water-resistant additive.

### Example Embodiments

In an aspect, embodiments described herein can provide a pickleball paddle for reducing the loudness and/or frequency of sound generated when a ball strikes the pickleball paddle, the paddle comprising a graphene infused acoustic layer applied on one or both sides of the paddle.

In some embodiments, the graphene infused acoustic layer can be a graphene infused felt, fabric, or foam, preferably fabric.

In some embodiments, the pickleball paddle is for reducing frequency of sound generated to 500-800 hz.

In some embodiments, the pickleball paddle further comprising one or more modifications selected from:
a) a subsurface layer between a core and an outer layer of the paddle, to increase bounce and reduce the trampoline effect;
b) a recessed insert in the core; and
c) a non-uniform weight distribution.

In some embodiments, the recessed insert comprise a radial shape.

In some embodiments, the recessed insert:
a. is X-shaped or Y-shaped; or
b. has a shape comprising 5 or more points radiating from the center of the recessed insert.

In some embodiments, the recessed insert is made from rubber, PVC, and/or foam.

In some embodiments, weight is distributed proximate to the corners of the pickleball paddle, relative to the rest of the paddle.

In some embodiments, a pickleball paddle is provided comprising:
a. a plurality of weight inserts distributed in the core proximate to the corners of the pickleball paddle;
b. one or more additional weight layers between the core and one or both of the two outer layers; and/or
c. one or more hollow spaces distributed in the core, wherein fewer hollow spaces are positioned proximate to the corners of the pickleball paddle relative to the rest of the paddle.

In some embodiments, the one or more additional weight layers are thicker proximate to the corners of the pickleball paddle, or wherein the one or more additional weight layers comprise pieces of said layers positioned proximate to the corners of the pickleball paddle.

In some embodiments, the one or more additional weight layers comprise carbon fiber and/or fibreglass layers.

In some embodiments, the one or more hollow spaces comprise:
a. a plurality of hollow bores, channels, grooves, or combinations thereof; and/or
b. a hollow recess having a radial shape along the horizontal and/or vertical axes of the paddle.

In some embodiments, a thin layer of liquid silicone is applied to the graphene infused acoustic layer.

In some embodiments, an edge of the pickleball paddle are serrated or ridged.

In some embodiments, a pickleball paddle core is at least partially made of sound-proofing material.

1. A pickleball paddle for reducing the loudness and/or frequency of sound generated when a ball strikes the pickleball paddle, wherein the paddle comprises a playing surface with an acoustic layer, wherein the acoustic layer comprises a graphene infused fabric which contains about 1% to about 25% by weight of graphene.

2. The pickleball paddle of claim 1, wherein the graphene infused fabric comprises between 5% to 15% by weight of the graphene.

3. The pickleball paddle of claim 1, wherein the graphene infused fabric comprises between 7% to 12% by weight of the graphene.

4. The pickleball paddle of claim 1, wherein the graphene infused fabric comprises approximately 10% by weight of the graphene.

5. The pickleball paddle of claim 1, wherein the graphene infused acoustic layer is applied on a surface layer of the paddle.

6. The pickleball paddle of claim 1, wherein the playing surface is covered with the graphene infused fabric.

7. The pickleball paddle of claim 1 further comprising an acoustic fabric edge.

8. The pickleball paddle of claim 1, wherein the graphene infused fabric comprises the graphene and at least one polymer.

9. The pickleball paddle of claim 8 wherein the graphene infused fabric comprises polymer fibers.

10. The pickleball paddle of claim 9 wherein the polymer fibers comprise nylon and/or polypropylene.

11. The pickleball paddle of claim 10 wherein the polymer fibers comprise N66.

12. The pickleball paddle of claim 11, comprising N66 infused with graphene powder.

13. The pickleball paddle of claim 1, wherein the graphene infused fabric comprises the graphene, N66 and polypropylene, wherein the graphene infused fabric comprises:
i. between 5% to 15% graphene,
ii. between 40% to 60% N66, and
iii. between 30% to 40% polypropylene.

14. The pickleball paddle of claim 8, wherein the graphene infused fabric comprises:
i. about 10% graphene,
ii. about 55% N66, and
iii. about 35% polypropylene.

15. The pickleball paddle of claim 3, wherein the graphene infused fabric further comprises a waterproofing additive.

16. The pickleball paddle of claim 1, wherein the acoustic layer comprises a shell encasing the pickleball paddle.

17. The pickleball paddle of claim 1, further comprising an internal graphene infused acoustic layer, wherein the internal graphene infused acoustic layer is sandwiched between two core layers.

18. The pickleball paddle of claim 1, comprising a layer of carbon fiber applied to the outside of the surface of the paddle.

19. The pickleball paddle of claim 1, wherein the pickleball paddle comprises one or more layers of carbon fiber board.

20. The pickleball paddle of claim 15, wherein the layer of carbon fiber is applied as a composite comprised of the acoustic layer applied over the carbon fiber layer.

21. A pickleball paddle for reducing the loudness and/or frequency of sound generated when a ball strikes the pickleball paddle, wherein the paddle comprises a surface, the surface comprising an acoustic layer, wherein the acoustic layer comprises graphene and at least one fabric, wherein the acoustic layer reduces a frequency of sound generated to between 500 hz to 800 hz, wherein the acoustic layer comprises an effective amount of graphene to enhance durability of the surface.

22. A pickleball paddle for reducing the loudness and/or frequency of sound generated when a ball strikes the pickleball paddle, wherein the paddle comprises a surface, the surface comprising a fabric acoustic layer to reduce a frequency of sound generated to between 500 hz to 800 hz.

23. A graphene infused fabric for a graphene infused acoustic layer of a paddle or racquet frame, the fabric comprising polymer fiber and between about 1% and about 25% by weight of graphene.
